(19) United States
(12) Patent Application Publication
(10) Pub. No.: US 2026/0001657 A1
(43) Pub. Date: Jan. 1, 2026

(54) STOWAWAY INCEPTOR AND METHODS THEREOF

(71) Applicant: Supernal, LLC, Irvine, CA (US)

(72) Inventors: Matthew BARRIENTOS, Aliso Viejo, CA (US); Alexander POZZI, Carlsbad, CA (US)

(73) Assignee: Supernal, LLC, Irvine, CA (US)

(21) Appl. No.: 19/320,130

(22) Filed: Sep. 5, 2025

Related U.S. Application Data
(63) Continuation of application No. 18/606,254, filed on Mar. 15, 2024, now Pat. No. 12,434,853.
(60) Provisional application No. 63/490,404, filed on Mar. 15, 2023.

(51) Int. Cl. B64D 43/00; B64C 1/14; G05G 9/047

(52) U.S. Cl. CPC B64D 43/00; B64C 1/1407; G05G 9/047; G05G 2009/04703

(57) ABSTRACT

A vehicle is provided. The vehicle may include: a cockpit including a cabin door; an inceptor, positioned on the cabin door, including at least a base portion and a controller portion; and a transition mechanism integrated into the cabin door that enables adjustment of the inceptor between a first configuration and a second configuration; wherein at least the controller portion of the inceptor is positioned outside of the cabin door in the first configuration; wherein the base portion and the controller portion of the inceptor are fully contained within a recess of the cabin door in the second configuration. Other aspects are described and claimed.

### CROSS REFERENCE TO RELATED APPLICATIONS

This application claims priority to U.S. application Ser. No. 18/606,254, filed Mar. 15, 2024, which itself claims priority to U.S. Provisional Application No. 63/490,404 filed Mar. 15, 2023, both of which are incorporated by reference herein in their entireties.

### TECHNICAL FIELD

Aspects of the present disclosure relate generally to techniques for adjusting a configuration of an inceptor in an aircraft and, more particularly, to techniques for transitioning the inceptor between a stowed configuration and a deployed configuration.

### BACKGROUND

Commonly referred to as “sticks,” inceptors cover a variety of pilot control devices on fixed- and rotary-wing aircraft including side sticks, center sticks, throttles, cyclics, collective levers, and the like. On aircraft containing fly-by-wire (FBW) systems (i.e., those fight control systems that utilize computers to process the flight control inputs made by the pilot), the inceptors transmit pilot inputs to the flight control computer, which translates them instantaneously to commands that adjust directional surfaces and power. Depending on the mounting location of the inceptor (e.g., down on the aircraft floor, on the doors, etc.), the pilot cabin may become crowded, which may correspondingly make ingress and egress to and from the cabin burdensome.

The present disclosure is accordingly directed to improved inceptor configurations and mounting methods that enable the inceptors to be stowed away when not in use. These improved inceptors may correspondingly increase freedom of movement in the cabin, particularly during ingress/egress. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, a stowaway inceptor is disclosed.

In one aspect, a vehicle is provided. The vehicle includes: a cockpit including a cabin door; an inceptor, positioned on the cabin door, including at least a base portion and a controller portion; and a transition mechanism integrated into the cabin door that enables adjustment of the inceptor between a first configuration and a second configuration; wherein at least the controller portion of the inceptor is positioned outside of the cabin door in the first configuration; wherein the base portion and the controller portion of the inceptor are fully contained within a recess of the cabin door in the second configuration.

In another aspect, a method of adjusting an inceptor positioned on a cabin door of a vehicle between a first configuration and a second configuration is provided. The method includes: receiving, at a transition mechanism of the inceptor, an indication to initiate an adjustment to a configuration of the inceptor; and facilitating, based on the receiving, the adjustment; wherein the inceptor comprises a controller portion and a base portion; wherein at least the controller portion of the inceptor is positioned outside of the cabin door in the first configuration; wherein the base portion and the controller portion of the inceptor are fully contained within a recess of the cabin door in the second configuration.

In yet another aspect, a cabin door assembly is provided. The cabin door assembly, includes: a cabin door; an inceptor integrated into the cabin door including at least a base portion and a controller portion; and a transition mechanism integrated into the aircraft cabin door that enables adjustment of the inceptor between a first configuration and a second configuration; wherein at least the controller portion of the inceptor is positioned outside of the cabin door in the first configuration; wherein the base portion and the controller portion of the inceptor are fully contained within a recess of the cabin door in the second configuration.

In yet another aspect, an inceptor is provided. The inceptor, includes: a base portion; a controller portion attached to the base portion; a plurality of buttons positioned around the controller portion; and a transition mechanism enabling adjustment of the inceptor between a first configuration and a second configuration; wherein the controller portion and the plurality of buttons are active in the first configuration and are inactive in the second configuration.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 depicts a stowaway inceptor in a first configuration, according to various aspects of the present disclosure.

FIG. 2 depicts the stowaway inceptor from FIG. 1 in a second configuration, according to various aspects of the present disclosure.

FIG. 3 depicts a stowaway inceptor in a second configuration according to another embodiment, according to various aspects of the present disclosure.

### DETAILED DESCRIPTION OF THE EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as “about,” “approximately,” “substantially,” and “generally,” are used to indicate a possible variation of ±10% of a stated or understood value. In addition, the term “between” used in describing ranges of values is intended to include the minimum and maximum values described herein. The use of the term “or” in the claims and specification is used to mean “and/or” unless explicitly indicated to refer to alternatives only or the alternatives are mutually exclusive, although the disclosure supports a definition that refers to only alternatives and “and/or.” As used herein “another” may mean at least a second or more.

As used herein, the term “vehicle” may refer to any type of vehicle, e.g., motor vehicles (e.g., cars, trucks, buses, etc.), railed vehicles (e.g., trains, etc.), amphibious vehicles (e.g., boats, etc.), aircraft (e.g., planes, helicopters, etc.), spacecraft, autonomous or semi-autonomous vehicles, and the like. Various embodiments of the present disclosure relate generally to electric vehicles, such as vehicles driven via one or more electric loads, components associated with the electrical loads, and monitoring systems for the electrical loads and/or the components associated with the electrical loads. The electric loads may be in the form of electric motors associated with one or more propellers of a vertical takeoff and landing vehicle.

Aircraft cabins, particularly those equipped with FBW systems, grapple with challenges related to the placement and utilization of inceptors such as side sticks, center sticks, throttles, and cyclics. These inceptors are essential for transmitting pilot inputs to flight control computers, thereby facilitating real-time adjustments to directional surfaces and power.

A variety of smaller types of aircraft exist that may be utilized to quickly and conveniently ferry passengers and objects between locations. One such aircraft, for example, is an electric vertical take-off and landing (eVTOL) vehicle. These aircraft, like many others, are conventionally controlled by inceptors that are mounted down to the aircraft floor or positioned on the flight deck. Some aircraft have adopted “sidestick” configurations, in which the inceptor(s) are mounted to a portion of the cabin side wall. In these configurations, cabin ingress/egress is generally achieved either via an exit in the rear area of the cockpit or via a climb-out hatch. In a side egress cabin (e.g., via an exit through a cabin side door), sidestick inceptors may impede exit and/or entry. The conventional mounting of inceptors, whether on the aircraft floor, doors, or other fixed locations, has resulted in restricted cabin spaces, which may hinder seamless ingress and egress for pilots.

Accordingly, a need exists for an inceptor configuration that may be conventionally operable during use but that also may be stowed away during periods of non-use. Such a configuration may enable unimpeded ingress/egress to and from an aircraft cabin and may also ensure that the inceptor is protected from the elements when the cabin side doors are opened.

Reference will now be made in detail to the exemplary embodiments of the present disclosure described below and illustrated in the accompanying drawings. Wherever possible, the same reference numbers will be used throughout the drawings to refer to same or like parts.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims.

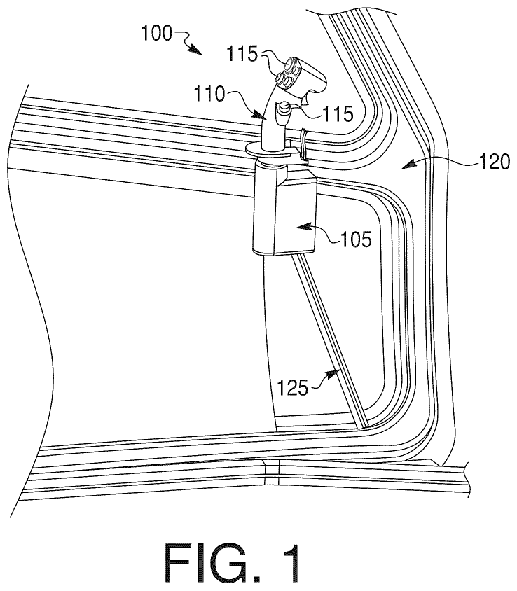

Referring now to FIG. 1, an exemplary inceptor 100 (“inceptor”) is provided. Inceptor 100 is a cockpit control that may be utilized by a user to control the movement and/or other functionalities of a vehicle. For simplicity purposes, the vehicle in the remaining disclosure described herein, and the figures associated therewith, is an electric powered VTOL aircraft. However, such a designation is not limiting and the concepts described herein may be applicable to virtually any type of vehicle, e.g., motor vehicles (e.g., cars, trucks, buses, motorcycles, etc.), railed vehicles (e.g., trains, etc.), amphibious vehicles (e.g., boats, etc.), aircraft (e.g., planes, helicopters, etc.), spacecraft, autonomous or semi-autonomous vehicles, and the like.

In an embodiment, inceptor 100 may contain base portion 105, joystick control 110, and plurality of action buttons 115 positioned thereon. In the associated figures and the following description, inceptor 100 is illustrated as being door-mounted, i.e., mounted to the side of one or more aircraft cabin doors (e.g., a sliding door, pocket door, swingout door, gullwing door, etc.). It is important to note, however, that the illustrated inceptor design and the mounting location are not limiting. More particularly, the embodiments described herein may be applicable to virtually any type of inceptor and may also be applicable to an inceptor mounted to virtually any other location within the vehicle cabin (e.g., cabin floor, cabin ceiling, an interior cabin wall, etc.).

In an embodiment, inceptor 100 may be hard-wired into the aircraft. More particularly, one or more wires may run from a central aircraft system to inceptor 100 via cabin door 120 to enable signal transfer. In another embodiment, inceptor 100 may communicate with the central aircraft system through wireless means, e.g., via a wireless communication modality such as BLUETOOTH, near field communication (NFC), and the like. In such an embodiment, the inceptor(s) may be decoupled from its mounted position and operated remotely. For instance, the inceptor may be a remote controller that can be attached to one or more predetermined areas within the cabin (e.g., via magnetic attachment, etc.) and, if desired by the user, subsequently detached therefrom. The user may utilize the detached inceptor in the same way that they would utilize the mounted inceptor. In yet another embodiment, a hybrid configuration may exist in which some portions of inceptor 100 are hard-wired into the aircraft whereas others may operate wirelessly. For example, base portion 105 of inceptor 100 may be integrated with the aircraft but controller portion 110 may be detachable. In such an embodiment, a rechargeable battery (e.g., a lithium-ion battery, etc.) of controller portion 110 may automatically charge when controller portion 110 is docked with base portion 105. Additionally or alternatively, upon re-docking with base portion 105, any controller or system updates that may have occurred while controller portion 110 was undocked from base portion 105 may be transmitted to controller portion 110.

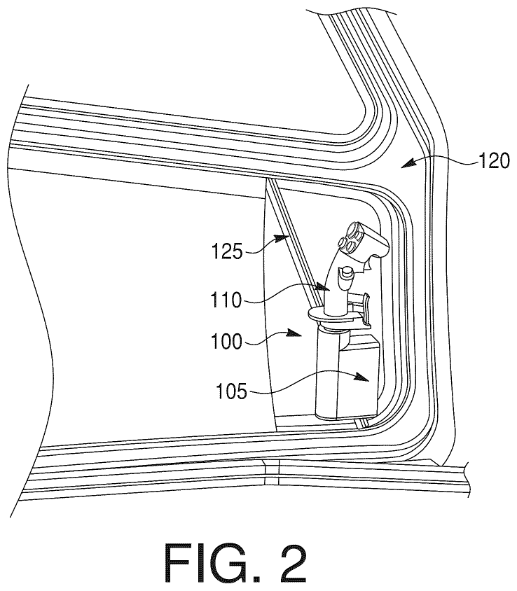

In an embodiment, inceptor 100 illustrated in FIG. 1 is presented in a first configuration. Inceptor 100 may be adjusted between the first configuration and a second configuration via utilization of a transition mechanism. In an embodiment, inceptor 100 in the first configuration may be considered to be in a “deployed” configuration, i.e., a configuration in which it is ready for use by the pilot, whereas inceptor 100 in the second configuration may be considered to be in a “stowed” configuration, i.e., a configuration in which it is contained within a recess of a cabin door). In an embodiment, one type of transition mechanism may be a sliding mechanism by which inceptor 100 may slide up and down track 125 integrated into a portion of cabin door 120. For instance, inceptor 100 may transition from the deployed configuration presented in FIG. 1 to a stowed configuration, as illustrated and presented in FIG. 2, via horizontal movement down track 125.

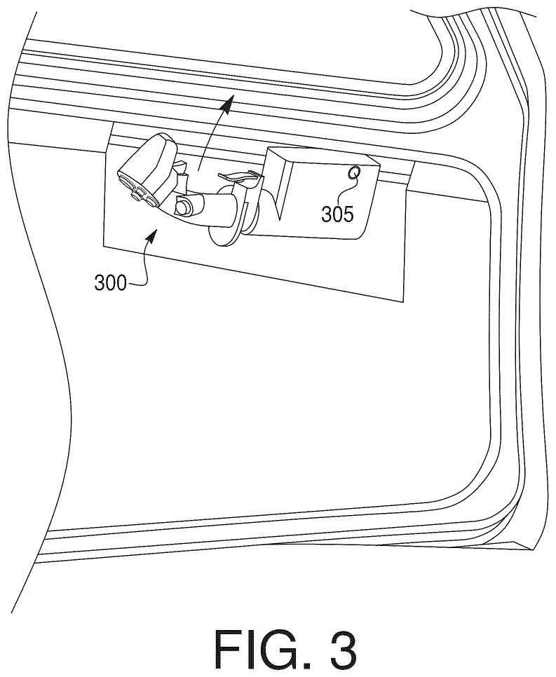

Referring now to FIG. 3, in another embodiment, a rotational mechanism is presented by which inceptor 300 may rotate about hinge point 305 to stow and deploy. More particularly, inceptor 300 in FIG. 3 is illustrated in a stowed configuration but may rotate about the hinge point as indicated to transition into the deployed configuration. In an embodiment, two or more transition mechanisms may be applicable to a single inceptor. For instance, a user may initially rotate an inceptor down within a recess of the cabin door 120, as illustrated in FIG. 3, and thereafter slide it further into the cabin door 120 along a track (e.g., via manual interaction, via interaction with a button, etc.), such as the one illustrated in FIGS. 1-2.

In an embodiment, the transitions described above may be instituted manually (e.g., via manual user adjustment, etc.). For instance, a user may manually interact with inceptor 100 to place it into the stowed configuration (e.g., a pilot may push a sliding mechanism-based inceptor down along the provided track 125 into the recess of the cabin door 120). As another example, a user may press, or press and hold, a button (e.g., positioned close to the inceptor location) that may be used to deploy and/or stow the inceptor (e.g., via utilization of a spring system, etc.). In another embodiment, the transition may be facilitated automatically, without additional user input. For example, the action of opening and closing the cabin door may dynamically actuate an inceptor to deploy or stow (e.g., opening a cabin door may automatically stow an inceptor and closing the cabin door may automatically deploy it, etc.). Additionally or alternatively, in another example, a flight control system of the aircraft may receive a signal indication that the aircraft has initiated flight systems and/or is about to take off and therefore correspondingly transmits an instruction to deploy the inceptor from its stowed configuration. In the alternative, the flight control system may detect that an aircraft has just landed and that the pilot will soon exit the cabin door and so then may dynamically initiation operations to stow the inceptor.

In an embodiment, certain functions of the aircraft may be disabled if an inceptor is not deployed or stowed. For instance, the aircraft may be apprised of current weather conditions (e.g., via sensors resident on the aircraft, by information obtained from a weather monitoring agency, etc.). Responsive to determining that adverse conditions (e.g., rain, snow, etc.) are present in the area of aircraft operation, the system may prevent the pilot from opening a cabin door unless the inceptor is maneuvered into a stowed configuration. In another embodiment, as a safety feature, all inceptors may initially be in a stowed configuration. To deploy them, the pilot must provide some type of indication that they are authorized to fly the aircraft. For instance, the pilot may be required to enter a passcode, undergo biometric authentication (e.g., via fingerprint analysis, facial recognition, etc.), and the like. Responsive to authenticating the pilot, the appropriate inceptor(s) may deploy. Conversely, if the pilot is unable to be authenticated, then the aircraft may prevent access to certain flight functions. Additionally or alternatively, a notification may be sent to one or more designated entities informing them of the failed authentication event (e.g., the aircraft owner, a law enforcement agency, an aviation administrator, etc.).

In an embodiment, two or more inceptors may exist within a single aircraft. For example, the aircraft cabin may contain two cabin side doors and each of the cabin side doors may contain a mounted inceptor. In such a situation, one inceptor may be fixed in place and the other inceptor may be adjustable between a deployed configuration and a stowed configuration using the techniques described above. For instance, an inceptor positioned on a smaller and/or less frequently used cabin door (e.g., a cabin door designated for emergency egress only, etc.) may be fixed in place whereas another inceptor positioned on a primary exit door may be adjustable. Alternatively, in another embodiment, either of the inceptors may be adjustable between the deployed and stowed configurations. In yet another embodiment, an external remote controller inceptor may also exist that is operable by an individual located outside of the aircraft. The external remote control inceptor may take operational command of the aircraft in certain situations (e.g., upon receipt of a distress call by the pilot, upon receipt of an alert signal from the aircraft system, etc.). In this situation, the interior aircraft inceptors may automatically stow, preventing the pilot from continuing to fly, and full flight control may be transferred to the external remote control inceptor.

In an embodiment, when two inceptors are present and both are deployed, each of the inceptors may have a subset of capabilities that, when utilized together, are able to control all necessary aircraft functions. In such an embodiment, when one of the inceptors is stowed away and the other remains deployed during aircraft operation, the capabilities of the stowed inceptor may be transferred to the deployed inceptor, which may correspondingly manifest full aircraft control. In another embodiment, each inceptor may be assigned a control designation (e.g., primary control, secondary control, etc.). The control designation may be assigned based on inceptor position (e.g., left cabin door inceptor is the primary control and right cabin door is the secondary control, etc.) or by an operating individual (e.g., if two pilots are present in a cabin cockpit, the inceptor associated with the more senior pilot may be the primary and the inceptor associated with the junior pilot may be the secondary, etc.). In a situation where the primary inceptor is stowed, the secondary inceptor may automatically be assigned full aircraft control. Upon deployment of the primary inceptor, full aircraft control may be automatically transferred away from the secondary inceptor and assigned to the primary inceptor.

The many features and advantages of the present disclosure are apparent from the detailed specification, and thus, it is intended by the appended claims to cover all such features and advantages of the present disclosure that fall within the true spirit and scope of the disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

Moreover, those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

What is claimed is:

1. A method of operating a vehicle, comprising:
detecting, at a flight control system of the vehicle, that a first inceptor configured to control a first set of vehicle functions and a second inceptor configured to control a second set of vehicle functions are both in a respective first configuration;
receiving, at the flight control system, an indication that the second inceptor transitioned from the first configuration to a second configuration;
transferring, by the flight control system, an operational capability of the second inceptor to control the second set of vehicle functions to the first inceptor based on the received indication; and
enabling, by the flight control system, the first inceptor to control the first set of vehicle functions and the second set of vehicle functions when the second inceptor is in the second configuration.

2. The method of claim 1, wherein the first configuration corresponds to a deployed configuration and wherein the second configuration corresponds to a stowed configuration.

3. The method of claim 1, further comprising:
receiving, at the flight control system, a second indication that the second inceptor is adjusted from the second configuration to the first configuration; and
automatically transferring the operational capability to control the second set of vehicle functions from the first inceptor to the second inceptor.

4. The method of claim 1, wherein the first set of vehicle functions and the second set of vehicle functions are based on a position of the first inceptor and the second inceptor inside a cabin of the vehicle.

5. The method of claim 1, wherein the first set of vehicle functions and the second set of vehicle functions are based on a seniority of a first operator controlling the first inceptor with respect to a second operator controlling the second inceptor.

6. The method of claim 1, wherein the vehicle is a vertical take-off and landing vehicle (VTOL).

7. A method of operating a vehicle, comprising:
detaching a controller portion of an inceptor from a base portion of the inceptor, wherein the base portion is integrated with a cabin door of the vehicle;
transmitting, via interacting with the detached controller portion and using a wireless communication protocol, one or more control signals to a flight control system of the vehicle; and
controlling at least one operational function of the vehicle based on the one or more control signals transmitted from the detached controller portion to the flight control system.

8. The method of claim 7, wherein the wireless communication protocol comprises at least one of: Bluetooth communication, near field communication (NFC), or Wi-Fi communication.

9. The method of claim 7, wherein the controller portion is configured to be magnetically attached to one or more predetermined locations within the cockpit.

10. The method of claim 7, wherein the controller portion comprises a joystick and a plurality of user-actuatable buttons.

11. The method of claim 7, further comprising:
reattaching the controller portion to the base portion; and
charging a battery of the controller portion via the base portion.

12. The method of claim 7, further comprising:
reattaching the controller portion to the base portion; and
transmitting one or more system updates from the base portion to the controller portion.

13. A method of operating a vehicle, comprising:
detecting, at a flight control system of the vehicle, an adverse environmental condition in a vicinity of the vehicle;
determining, using the flight control system, that at least one inceptor of the vehicle is in a first configuration rather than a second configuration; and
disabling a functionality of a cabin door of the vehicle to be opened based on the detecting and the determining.

14. The method of claim 13, wherein the detecting the adverse environmental comprises detecting using at least one: sensor data or third-party data.

15. The method of claim 13, wherein the adverse environmental condition corresponds to one or more of: rain, snow, or wind above a predetermined threshold.

16. The method of claim 13, wherein the first configuration is a deployed configuration and wherein the second configuration is a stowed configuration.

17. The method of claim 13, further comprising automatically adjusting, by the flight control system, the at least one inceptor to the second configuration.

18. The method of claim 13, further comprising:
receiving, at the flight control system, an indication that the at least once inceptor is adjusted to the second configuration from the first configuration; and
enabling, by the flight control system, the functionality of the cabin door to be opened.

19. The method of claim 18, further comprising verifying an authorization of an operator of the vehicle prior to facilitating adjustment of the at least one inceptor from the second configuration to the first configuration.

20. The method of claim 19, wherein verifying the authorization comprises one or more of: receiving a passcode input or performing biometric authorization.
